(19) United States
(12) Patent Application Publication
(10) Pub. No.: US 2024/0380597 A1
(43) Pub. Date: Nov. 14, 2024

(54) REMOTE IDENTITY INTERACTION

(71) Applicant: Visa International Service Association, San Francisco, CA (US)

(72) Inventors: Eduardo Lopez, Menlo Park, CA (US); Pinesh Roy, Redwood City, CA (US)

(73) Assignee: Visa International Service Association, San Francisco, CA (US)

(21) Appl. No.: 18/696,294

(22) PCT Filed: Sep. 13, 2022
(86) PCT No.: PCT/US2022/043332

§ 371 Date: Mar. 27, 2024

Related U.S. Application Data
(60) Provisional application No. 63/251,448, filed on Oct. 1, 2021.

(51) Int. Cl. H04L 9/32; G06Q 20/40

(52) U.S. Cl. CPC H04L 9/3213; G06Q 20/40145; H04L 9/3231; H04L 2209/56

(57) ABSTRACT

One embodiment of the invention is directed to a method comprising: receiving, by a token requestor computer from a point of interaction device, verification of authentication data and the linking data; determining, by the token requestor computer, a token based on the linking data after analyzing the verification of the authentication data; transmitting, by the token requestor computer to a token service computer, a cryptogram request message; receiving, by the token requestor computer from the token service computer, a cryptogram associated with the token; generating, by the token requestor computer, an authorization request message comprising the token and the cryptogram to a processor computer; and receiving, by the token requestor computer, an authorization response message from the processor computer.

### CROSS-REFERENCES TO RELATED APPLICATIONS

This application is a PCT application which claims priority to U.S. Provisional Application No. 63/251,448, filed on Oct. 1, 2021, which is herein incorporated by reference in its entirety.

### BACKGROUND

Prior methods can use credentials to conduct interactions and biometrics to verify users conducting those interactions. For example, a user may use a transit card to interact with an access terminal to gain access to a secure location. The transit card can have a credential such as an account identifier. The user may need to authenticate themselves to the access terminal and present the transit card to the access terminal before the access terminal allows the user to enter the secure location. In another example, a user may use a payment card to interact with an access device to obtain services from a resource provider. The user may need to authenticate themselves and present a credential such as an account number before they are allowed to obtain the services.

Several problems are associated with interactions of this type. First, the credential is passed from the user or the user's device at the point of interaction to the access terminal. This makes the credential vulnerable to hacking or interception by a man-in-the-middle. Second, the interaction is inconvenient, since the user needs to present both the device bearing the credential and their biometric to gain access to the location. More secure and convenient interactions systems and methods are needed.

Embodiments of this disclosure address these and other problems, individually and collectively.

### SUMMARY

One embodiment of the invention is directed to a method comprising: receiving, by a token requestor computer from a point of interaction device, verification of authentication data, and linking data; determining, by the token requestor computer, a token based on the linking data after analyzing the verification of the authentication data; transmitting, by the token requestor computer to a token service computer, a cryptogram request message; receiving, by the token requestor computer from the token service computer, a cryptogram associated with the token; transmitting, by the token requestor computer, an authorization request message comprising the token and the cryptogram to a processor computer; and receiving, by the token requestor computer, an authorization response message from the processor computer.

Another embodiment includes a token requestor computer comprising: a processor; and a non-transitory computer readable medium, the non-transitory computer readable medium comprising code executable by the processor to perform a method comprising: receiving, from a point of interaction device, verification of authentication data, and linking data; determining a token based on the linking data after analyzing the verification of the authentication data; transmitting, to a token service computer, a cryptogram request message; receiving, from the token service computer, a cryptogram associated with the token; transmitting an authorization request message comprising the token and the cryptogram to a processor computer; and receiving an authorization response message from the processor computer.

Another embodiment includes a method, comprising: receiving, by a point of interaction device, authentication data from a user; initiating, by the point of interaction device, verifying the authentication data with an identity service provider computer; receiving, by the point of interaction device, verification of the authentication data, and linking data associated with the authentication data; providing, by the point of interaction device, the verification of the authentication data, and the linking data to a token requestor computer, wherein the token requestor computer determines a token based on the linking data after analyzing the verification of the authentication data, requests and receives a cryptogram associated with the token from a token service computer, and transmits an authorization request message comprising the token and the cryptogram to a processor computer.

Another embodiment includes a point of interaction device comprising a processor; and a non-transitory computer readable medium coupled to the processor, the non-transitory computer readable medium comprising code executable by the processor for implementing a method, comprising: receiving, by a point of interaction device, authentication data from a user; initiating, by the point of interaction device, verifying the authentication data with an identity service provider computer; receiving, by the point of interaction device, verification of the authentication data and linking data associated with the authentication data; providing, by the point of interaction device, the verification of the authentication data, and the linking data to a token requestor computer, wherein the token requestor computer determines a token based on the linking data after analyzing the verification of the authentication data, requests and receives a cryptogram associated with the token from a token service computer, and generates and transmits an authorization request message comprising the token and the cryptogram to a processor computer.

Further details regarding embodiments of the invention can be found in the Detailed Description and the Figures.

### BRIEF DESCRIPTION OF THE DRAWINGS

FIG. 1 shows an exemplary system and an enrollment process flow diagram, in accordance with embodiments.

FIG. 2 shows an exemplary system and a process flow diagram illustrating an interaction method according to embodiments.

FIG. 3 shows a block diagram of an exemplary point of interaction device according to embodiments.

FIG. 4 shows a block diagram of an exemplary token requestor computer according to embodiments.

FIG. 5 shows a block diagram of an exemplary identity service provider computer according to embodiments.

FIG. 6 shows a block diagram of an exemplary token service computer according to embodiments.

### DETAILED DESCRIPTION

Prior to discussing embodiments of the invention, some terms can be described in further detail.

A “user” may include an individual or a computing device. In some embodiments, a user may be associated with one or more personal accounts and/or mobile devices. In some embodiments, the user may be a cardholder, account holder, or user.

A “user device” may be any suitable device operated by a user. User devices may be in any suitable form. Some examples of user devices include cellular phones, smartphones, mobile phones, PDAs, personal computers (PCs), tablet computers, and the like. In some embodiments, where a user device is a mobile device, the mobile device may include a display, a memory, a processor, a computer-readable medium, and any other suitable component. Specific examples of user devices can include a point of interaction device or biometric enrollment device. A point-of-interaction device can be a user device that is used at a point of interaction or can be a user device that initiates an interaction. A biometric enrollment device can be a device that can be used to enroll a biometric into an interaction processing system.

A “mobile device” may comprise any suitable electronic device that may be transported and operated by a user, which may also provide remote communication capabilities to a network. A mobile device such as a mobile communication device may communicate using a mobile phone (wireless) network, wireless data network (e.g., 3G, 4 G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e., using the other device as a modem—both devices taken together may be considered a single mobile device).

An “access device” may be any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. In some embodiments, an access device may use any suitable contact or contactless mode of operation to send or receive data from, or associated with, a mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a mobile device.

“Authentication data” may include any data suitable for authenticating a user or device. Authentication data may be obtained from a user or a device that is operated by the user. Examples of authentication data obtained from a user may include PINs (personal identification numbers), biometric data (e.g., fingerprint, facial scan, retina scan, etc.), passwords, etc. Examples of authentication data that may be obtained from a device may be include device serial numbers, hardware secure element identifiers, device fingerprints, phone numbers, IMEI numbers, etc.

A “digital wallet” can include an electronic device that allows an individual to conduct electronic commerce transactions. A digital wallet may store user profile information, credentials, bank account information, one or more digital wallet identifiers and/or the like and can be used in a variety of transactions, such as, but not limited to, e-commerce transactions, social network transactions, money transfer/personal payment transactions, mobile commerce transactions, proximity payment transactions, gaming transactions, etc. A digital wallet may be designed to streamline the purchase and payment process. A digital wallet may allow the user to load one or more payment cards onto the digital wallet to make a payment without having to enter an account number or present a physical card. A provider (e.g., an entity that hosts the digital wallet) may be referred to as a “digital wallet provider. ”

A “biometric” may be any human characteristic that is unique to an individual. For example, a biometric may be a person's fingerprint, voice sample, face, DNA, retina, etc.

A “biometric reader” may include a device for capturing data from an individual's biometric sample. Examples of biometric readers may include fingerprint readers, front-facing cameras, microphones, and iris scanners.

A “biometric sample” may include data obtained by a biometric reader. The data may be either an analog or digital representation of the user's biometric, generated prior to determining distinct features needed for matching. For example, a biometric sample of a user's face may be image data. In another example, a biometric sample of a user's voice may be audio data.

A “biometric template” or “biometric sample template” may include a file containing distinct characteristics extracted from a biometric sample that may be used during a biometric authentication process. For example, a biometric template may be a binary mathematical file representing the unique features of an individual's fingerprint, eye, hand or voice needed for performing accurate authentication of the individual.

“Biometric data” includes data that can be used to uniquely identify an individual based upon one or more intrinsic physical or behavioral traits. For example, biometric data may include fingerprint data and retinal scan (e.g., eye scan) data. Further examples of biometric data include digital photographic data (e.g., facial recognition data), deoxyribonucleic acid (DNA) data, palm print data, hand geometry data, and iris recognition data. Biometric data can include a biometric sample or a biometric template.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc. Other examples of credentials include PANs (primary account numbers), PII (personal identifiable information) such as name, address, and phone number, and the like.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided to make a payment from a payment account. Payment credentials can also include a username, an expiration date, a gift card number or code, and any other suitable information.

An “authorizing entity” may be an entity that authorizes a request, typically using an authorizing computer to do so. An authorizing entity may be an issuer, a governmental agency, a document repository, an access administrator, etc. An “issuer” may typically include a business entity (e.g., a bank) that maintains an account for a user. An issuer may also issue payment credentials stored on a user device, such as a cellular telephone, smart card, tablet, or laptop to the user. A computing device operated by or on behalf of an authorizing entity may be referred to as an “authorizing entity computer. ”

A “resource provider” can be any suitable entity that provides resources (e.g., goods, services, access to secure data, access to locations, or the like). For example, a resource providing entity can be a merchant, a payment processor, a digital wallet provider, a venue operator, a building owner, a governmental entity, etc. A “merchant” may typically be an entity that engages in transactions and can sell goods or services, or provide access to goods or services. A computing device operated by or on behalf of a resource provider may be referred to as a “resource provider computer.”

A “secure server computer” can be a server computer that securely stores data. As a non-limiting example, a secure server computer can be part of a partner's cloud-computing environment. A “cloud-computing environment” may include a network of one or more server computers hosted on a network (e.g., the Internet) that are utilized to store, manage, and process data.

An “acquirer” may typically be a business entity (e.g., a commercial bank) that has a business relationship with a resource provider. Some entities can perform both issuer and acquirer functions. Some embodiments may encompass such single entity issuer-acquirers. A computing device operated by or on behalf of a resource provider may be referred to as a “transport computer. ”

A “token provider computer” or “token service computer” can include an electronic device that services payment tokens and/or cryptograms. In some embodiments, a token provider computer can facilitate requesting, determining (e.g., generating) and/or issuing (provisioning, transmitting, etc.) tokens and/or cryptograms, as well as maintaining an established mapping of tokens to primary account numbers (PANs) (e.g., real account identifiers) and/or cryptograms in a repository. In some embodiments, the token provider computer may establish a token assurance level for a given token to indicate the confidence level of the token to PAN binding. The token provider computer may include or be in communication with a token data store wherein the generated tokens/cryptograms are stored. The token provider computer may support token processing of payment transactions submitted using tokens by de-tokenizing the token to obtain the actual PAN. In some embodiments, a token provider computer may include a tokenization computer alone, or in combination with other computers such as a transaction processing computer. Various entities of a tokenization ecosystem may assume the roles of the token provider computer. For example, payment networks and issuers or their agents may become the token provider computer by implementing the token services according to embodiments of the present invention.

A “processor computer” may include a server computer that is used process data. In some embodiments, a processor computer can be for processing transactions from a network. In some embodiments, the processor computer may be coupled to a database and may include any hardware, software, other logic, or combination of the preceding for servicing the requests from one or more client computers or user devices. The processor computer may comprise one or more computational apparatuses and may use any of a variety of computing structures, arrangements, and compilations for servicing the requests from one or more client computers or user devices. In some embodiments, the processor computer may operate multiple server computers. In such embodiments, each server computer may be configured to process a transaction for a given region or manages transactions of a specific type based on transaction data.

The processor computer may include data processing subsystems, networks, and operations used to support and deliver authorization services, exception file services, and clearing and settlement services. An exemplary processor computer may include VisaNet™. Networks that include VisaNet™ can process credit card transactions, debit card transactions, and other types of commercial transactions. VisaNet™ includes an integrated payments system (Integrated Payments system) which processes authorization requests and a Base II system, which performs clearing and settlement services. The processor computer may use any suitable wired or wireless network including the Internet.

The processor computer may process transaction-related messages (e.g., authorization request messages and authorization response messages) and determine the appropriate destination computer (e.g., issuer computer/authorizing entity computer) for the transaction-related messages. In some embodiments, the processor computer may authorization transactions on behalf of an issuer. The processor computer may also handle and/or facilitate the clearing and settlement of financial transactions.

A “cryptographic key” (also referred to as a “key”) may include a piece of information that is used in a cryptographic algorithm to transform data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “limited use key” may include a cryptographic key for which use is limited. By way of example, a limited use key may be a cryptographic key associated with a limited use threshold. A limited-use threshold may be exceeded or exhausted when an underlying condition is met. For example, a limited-use threshold may include a time-to-live that indicates an amount of time for which a piece of information (e.g., a limited use key) is valid, and once that amount of time has elapsed, the limited-use threshold is exceeded or exhausted, and the piece of information (e.g., the limited use key) may become invalid and may no longer be used. As another example, a limited-use threshold may include a number of times that a piece of information (e.g., the limited use key) can be used, and once the piece of information (e.g., the limited use key) has been used for that number of times, the limited-use threshold is exceeded or exhausted, and the piece of information (e.g., the limited use key) may become invalid and may no longer be used. A limited use key may be derived from account data of a user, and may be provided to a user device operated by a user. It may alternatively be generated by the user device.

A “cryptogram” may include an encrypted representation of some information. A cryptogram may include a token authentication verification value (TAVV) associated with a token. A cryptogram can be used by a recipient to determine if the generator of the cryptogram is in possession of a proper key, for example, by encrypting the underlying information with a valid key, and comparing the result to the received cryptogram. A cryptogram may include encrypted characters. Cryptograms can be of any suitable length and may be formed using any suitable data transformation process. Exemplary data transformation processes include encryption, and encryption processes such as DES, triple DES, AES, and ECC may be used. Keys used with such encryption process can be of any appropriate length and may have any suitable characteristics. In some embodiments, a cryptogram may include encrypted token data associated with a token (e.g., a token domain, a token expiry date, etc.). In some embodiments, a cryptogram may be used to validate the token. For example, a cryptogram may be used to validate that the token is being used within a token domain and/or by a token expiry date associated with the token. In some embodiments, a cryptogram may be used in a payment process, and may be generated by a card or device with the unique derivation key (UDK) or a limited-use key (LUK) and additional information (e.g., a primary account number, token, and/or information from a chip and point-of-sale (POS)). Different types of payment cryptograms can be used in different settings.

A “master derivation key” (MDK) can be a key used to generate other keys. An MDK may be managed by an issuer of an account. MDKs may be managed on a per bank identification number (BIN) basis. The MDK may be used for card production, payment processing, etc. In some embodiments, an MDK may be managed by a processor computer that performs token management functions. Such an MDK may be used for token management and validation.

A “cryptogram generation key,” (e.g., a unique derivation key (UDK)), can be a key for generating cryptograms. A cryptogram generation key may be generated from an MDK, directly or by way of another key. In some embodiments, a cryptogram generation key is a per-card key. The cryptogram generation key may be stored on a chip on a card or a device (e.g., mobile phone).

A “real account identifier” may include an original account identifier associated with a payment account. For example, a real account identifier may be a primary account number (PAN) issued by an issuer for a card account (e.g., credit card, debit card, etc.). For instance, in some embodiments, a real account identifier may include a sixteen digit numerical value such as “4147 0900 0000 1234.” The first six digits of the real account identifier (e.g., “414709 ”), may represent a real issuer identifier (BIN) that may identify an issuer associated with the real account identifier.

A “token” may be a substitute value for a credential. A token may be a string of numbers, letters, or any other suitable characters. Examples of tokens include payment tokens, access tokens (e.g., for accessing a location), personal identification tokens, etc.

A “payment token” may include an identifier for a payment account that is a substitute for an account identifier, such as a primary account number (PAN). For example, a token may include a series of alphanumeric characters that may be used as a substitute for an original account identifier. For example, a token “4900 0000 0000 0001 ” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “token request message” may be an electronic message for requesting a token. A token request message may include information usable for identifying a payment account (e.g., a real account identifier) or a service provider account (e.g., a digital wallet account), and/or information for generating a token (e.g., a payment token) and/or a unique cryptogram (e.g., a TAVV).

A “token response message” may be a message that responds to a token request message. A token response message may include an indication that a token request was approved or denied. A token response message may also include a token (e.g., a payment token), a cryptogram (e.g., a TAVV), and/or any other suitable information.

A “token domain” may indicate an area and/or circumstance in which a token can be used. Examples of the token domain may include, but are not limited to, payment channels (e.g., e-commerce, physical point of sale (POS), etc.), POS entry modes (e.g., contactless, magnetic stripe, etc.), and resource provider identifiers (e.g., merchant identifiers) to uniquely identify where the token can be used. A set of parameters (i.e., token domain restriction controls) may be established as part of token issuance by the token service provider that may allow for enforcing appropriate usage of the token in transactions. For example, the token domain restriction controls may restrict the use of the token with presentment modes, such as contactless or e-commerce presentment modes. In some embodiments, the token domain restriction controls may restrict the use of the token at a particular resource provider (e.g., a merchant) that can be uniquely identified. Some exemplary token domain restriction controls may require the verification of the presence of a token cryptogram that is unique to a given transaction. In some embodiments, a token domain can be associated with a token requestor.

“Token expiry date” may include the expiration date/time of the token. The token expiration date may be a numeric value (e.g., a 4-digit numeric value). In some embodiments, the token expiry date can be expressed as a time duration as measured from the time of issuance.

A “cryptogram request message” may be an electronic message for requesting a cryptogram. A cryptogram request message may include information usable for identifying a payment account (e.g., a real account identifier) or a service provider account (e.g., a digital wallet account), and/or information for generating a cryptogram. A cryptogram request message may be in the same or a different format than a token request message.

A “cryptogram response message” may be a message that responds to a cryptogram request message. A cryptogram response message may include an indication that a cryptogram request was approved or denied. A cryptogram response message may include a cryptogram (e.g., a TAVV), and/or any other suitable information. A cryptogram response message may be in the same or a different format than a token response message.

The term “authentication” and its derivatives may include a process by which the credential of an endpoint (including but not limited to applications, people, devices, processes, and systems) can be verified to ensure that the endpoint is who they are declared to be.

The term “verification” and its derivatives may include a process that utilizes information to determine whether an underlying subject is valid under a given set of circumstances. Verification may include any comparison of information to ensure some data or information is correct, valid, accurate, legitimate, and/or in good standing.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” is typically a powerful computer or cluster of computers. For example, the server computer can be a large mainframe, a minicomputer cluster, or a group of servers functioning as a unit. In one example, the server computer may be a database server coupled to a Web server. A server computer may also be cloud based and may involve the distribution of a number of different computers in the cloud.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

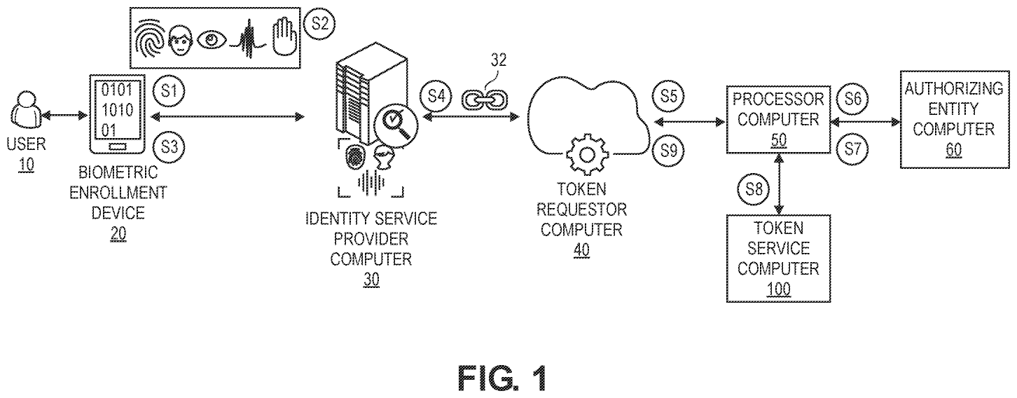

FIG. 1 shows a diagram illustrating an enrollment and token provisioning process and system according to embodiments. FIG. 1 shows a biometric enrollment device 20 in communication with an identity service provider computer 30. The identity service provider computer 30 can be in communication with a token requestor computer 40, which may be a service provider/token requestor cloud server system in some embodiments. The token requestor computer 40 can be in communication with a processor computer 50. The system further includes a token service computer 100, which is in turn in communication with the processor computer 50. In some cases, the processor computer 50 and the token service computer 100 can be components in a payment processing network. The processor computer 50 may also be in communication with an authorizing entity computer 60.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

An enrollment method can be described with reference to FIG. 1.

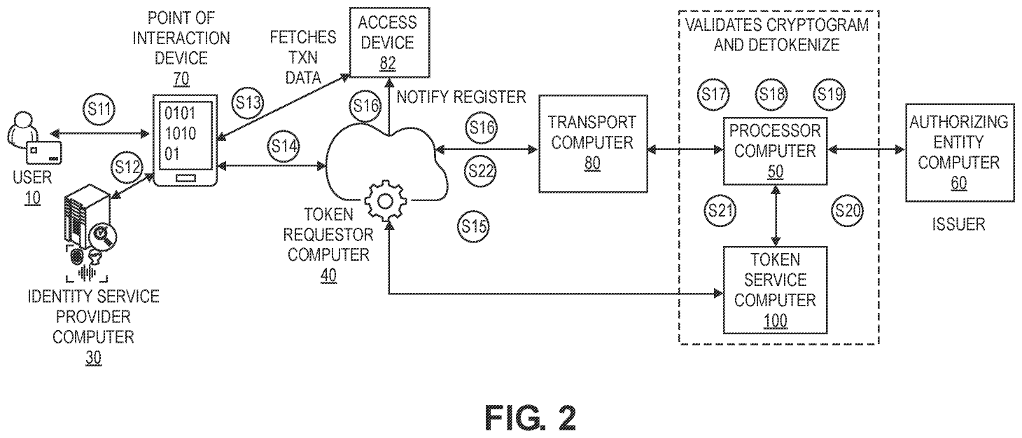

In step S1, a user 10 (e.g., a consumer) can register his biometric sample with an identity service provider computer 30 via a biometric enrollment device 20. The biometric enrollment device 20 may be a mobile phone or other mobile device. The biometric enrollment device 20 may be the same or different than the point of interaction device 70, which will be discussed below with respect to FIG. 2.

As an illustration, the biometric enrollment device 20 may have a biometric capture application on it, and may capture a biometric such as a fingerprint, retinal scan, etc. of the user to obtain a biometric sample of the user. In some embodiments, the biometric enrollment device 20 may convert the biometric sample to a biometric template. The biometric sample or the biometric template may then be transmitted by the biometric enrollment device 20 to the identity service provider computer 30 in an enrollment request message. Other identifying data may be optionally included in the enrollment request message to create the account. Such data may include a communication address such as an e-mail address or phone number, or a username.

In step S2, after the identity service provider computer 30 receives the biometric sample from the biometric enrollment device 20, the identity service provider computer 30 can create an account for the user 10. The identity service provider computer 30 can provide a profile that can accompany the account of the user 10, and the profile may include the above described other identifying data.

In step S3, after the account for the user 10 is created, the user 10 can register his credential with the identity service provider computer 30. The credential could be employee identification information, payment card information (e.g., a PAN), driver's license information, social security information, etc. The user 10 may input the credential information into the biometric enrollment device 20, which may then send the credential to the identity service provider computer 30.

In step S4, after receiving the credential and biometric sample, the identity service provider computer 30 can then generate linking data 32 that links the user's credential and their biometric sample. The linking data 32 can be in any suitable form. For example, the linking data 32 can be an alphanumeric string of characters that uniquely identifies a linkage between the credential and the biometric sample. The identity service provider computer 30 can then store the linking data 32 and the credential in a database.

The identity service provider computer 30 can then provide the linking data 32 and the credential (e.g., payment card information such as a PAN) to the token requestor computer 40. The token requestor computer 40 can then store the linking data 32 along with a token corresponding to the credential (which is later received in step S9 as described below). The token may be encrypted when it is stored by the token requestor computer 40. The token may be encrypted using a cryptographic key such as a private key or symmetric key of the token requestor computer 40.

In step S5, after receiving the linking data and the credential, the token requestor computer 40 can send to a token request message comprising the credential to the processor computer 50. In some embodiments, the token requestor computer 40 can delete the credential after transmitting it to the processor computer 50.

In step S6, after receiving the token request message comprising the credential, the processor computer 50 can send the token request message comprising the credential to the authorizing entity computer 60. The authorizing entity computer 60 can evaluate the credential and can determine if a token can or cannot be issued for it. For example, the authorizing entity computer 60 can determine if the credential is in good standing (e.g., active, not linked to fraudulent activity, etc.).

In step S7, after determining that the received credential is in good standing, and after determining that a token can be issued for the credential, the authorizing entity computer 60 can send a token response message comprising a provisioning approval indicator to the processor computer 50.

In step S8, after receiving the token response message, the processor computer 50 can evaluate the provisioning approval indicator. If provisioning of the token is approved, then the processor computer 50 can communicate with the token service computer 100 to obtain a token. The token service computer 100 can retrieve the token from a pre-existing pool of tokens or can generate the token in response to the communication from the processor computer 50.

In step S9, after the token is obtained, the processor computer 50 can send the token to the token requestor computer 40. After receiving the token, the token requestor computer 40 can store it in association with the biometric and the linking data in the database.

After step S9, the user's biometric sample is enrolled and a token is stored at the token requestor computer 40. The user may then conduct future interactions with their biometric sample. An exemplary interaction is illustrated in FIG. 2.

FIG. 2 shows an interaction processing system with an overlaid interaction process flow. FIG. 2 shows a user 10 that can interact with a point of interaction device 70 to conduct an interaction to obtain a resource such as access to a secure location, access to secure data, or access to goods and/or services. The point of interaction device 70 can be in communication with the identity service provider computer 30 and an access device 82. The access device 82 may be operated by a resource provider such as a secure data access source, a secure location access organization, or a merchant. In some embodiments, the access device 82 could be a POS terminal or Web server operated by a resource provider such as a merchant. The token requestor computer 40 is in communication with a transport computer 80, the processor computer 50, and the authorizing entity computer 60. The token service computer 100 can be in communication with the processor computer 50.

Each of the entities in FIG. 2 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

In step S11, the user 10 scans his biometric (or other authentication data) at the point of interaction device 70 to produce a biometric sample.

In step S12, after generating the biometric sample, the point of interaction device 70 provides (e.g., transmits) the biometric sample to the identity service provider computer 30. After receiving the biometric sample, the identity service provider computer 30 validates the biometric sample by comparing it to the biometric sample that was stored during the enrollment process described above with respect to FIG. 1. The identity service provider computer 30 then sends back a response to the point of interaction device 70 that the biometric sample has been validated. The identity service provider computer 30 may also transmit the linking data that links the biometric sample to the credential (and therefore the token and the user 10) to the point of interaction device 70.

In step S13, before or after the point of interaction device 70 receives the linking data and the verification of the biometric sample, the point of interaction device device 12 obtains interaction data (e.g., transaction data such as a transaction amount, a merchant ID, an access device ID, an access device address, an interaction identifier, etc.) from the access device 82. The interaction data can include data from a resource provider that is needed to complete an interaction between the user 10 and the resource provider. The user 10 may be conducting an interaction with the access device to obtain a resource such as access to a secure location, secure data, or goods and/or services.

In step S14, after the point of interaction device 70 obtains the interaction data from the access device 82 and the linking data and the verification of the authentication data, the point of interaction device 70 sends the transaction data from the access device 82, the linking data from the identity service provider computer 30, and the verification of authentication data created by the identity service provider computer 30 to the token requestor computer 40. The token requestor computer 40 can then initiate the interaction (e.g., a transaction such as a secure data access transaction, a secure location access transaction, a payment transaction, etc.). Since the token requestor computer 40 is starting the transaction, then the transaction can be characterized as a “card-not-present” type of transaction.

In step S15, the token requestor computer 40 then identifies and obtains the token using the linking data. If the token is encrypted, then the token requestor computer 40 decrypts the token. The token requestor computer 40 then generates a cryptogram request message comprising the token and transmits the cryptogram request message comprising the token to the token service computer 100. After receiving the token service computer 100, the token service computer 100 can then obtain the cryptogram and then transmit it to the token requestor computer 40.

In some embodiments, the cryptogram can be generated by the token service computer 100. The cryptogram can be generated by concatenating information including one or more of the token, a time and/or date of creation, an expiration date, and other information, encrypting the concatenated information with a key such as a limited use key (LUK) to form an encrypted value, and optionally truncating the encrypted value to a predetermined number of digits.

In step S16, after the token requestor computer 40 obtains cryptogram, the token, and the interaction data, then the token requestor computer 40 generates an authorization request message with the token, the interaction data (e.g., a transaction amount or other value, a transaction identifier, etc.), and the cryptogram. The token requestor computer 40 then transmits the authorization request message to the transport computer 80.

In other embodiments, the token requestor computer 40 could provide the cryptogram to the access device 82, and the access device 82 could generate the authorization request message and transmit it to the token requestor computer 40. The token requestor computer 40 could then transmit the authorization request message to the transport computer 80.

In step S17, after receiving the authorization request message, the transport computer 80 route the authorization request message to the processor computer 50. The transport computer 80 may be one of many transport computers that route messages to the processor computer 50, which may be in a payment processing network.

In step S18, after the processor computer 50 receives the authorization request message, the processor computer 50 initations validation the cryptogram and communicates with the token service computer 100 to detokenize the token to obtain the credential associated with the token. The token service computer 100 receives the token and looks up the credential corresponding to the token in a database, and returns the credential to the processor computer 50. The token service computer 110 can also validate the cryptogram. In some some embodiments the cryptogram can be created by concatenating information including one or more of the received token, a time and/or date of creation, an expiration date, and other information, encrypting the concatenated information with a key such as a limited use key (LUK) to form an encrypted value, and optionally truncating the encrypted value to a predetermined number of digits. The predetermined digits can be compared to the cryptogram to validate it.

In some cases, the token may have domain restrictions associated with it. Those restrictions may be stored in the token service computer 100 when the cryptogram was created by the token service computer in step S15. For instance, the access device 82 could be a Web server and the cryptogram would only be valid for Internet interactions. If the authorization request message that is received by the processor computer 50 has an indicator that it is an interaction that is occurring at a physical point of sale at a physical location, then the processor computer 50 could decline the authorization request message or pass an indicator to the authorizing entity computer 60 that the current interaction and the domain restriction associated with the token and the cryptogram are not consistent.

In step S19, the processor computer 50 modifies the authorization request message by replacing the token with the credential, and the modified authorization request message is transmitted to the authorizing entity computer 60. After receiving the authorization request message with the credential, the authorizing entity computer 60 authorizes or declines the transaction. The authorizing entity computer 60 can determine if the credential is in good standing or not (e.g., the credential is not on a negative list, an account associated with the credential has sufficient funds, etc.). The authorizing entity computer 60 can then generate an authorization indicator (e.g., indicating whether the interaction is approved or declined).

In step S20, the authorizing entity computer 60 generates and sends an authorization response message comprising the credential back to the processor computer 50. The processor computer 50, upon receiving the authorization response message comprising the credential, can contact the token service computer 100 to exchange the credential in the authorization response message for the token.

In step S21, the processor computer 50 sends the modified authorization response message comprising the token back to the transport computer 80.

In step S22, after receiving the modified authorization response message, the transport computer 80 sends the authorization response message comprising the token to the token requestor computer 40.

After receiving the authorization response message from the transport computer 80, the token requestor computer 40 notifies the access device 82 that the authorization process is complete. The token requestor computer 40 can use the address of the access device 82 in the interaction data received in step S13 to send the notification of completion back to the access device 82.

At the end of the day or at any other suitable time, a clearing and settlement process can occur. Real funds for the transaction can be transferred from an account associated with the credential to the transport computer 80 via the processor computer 50.

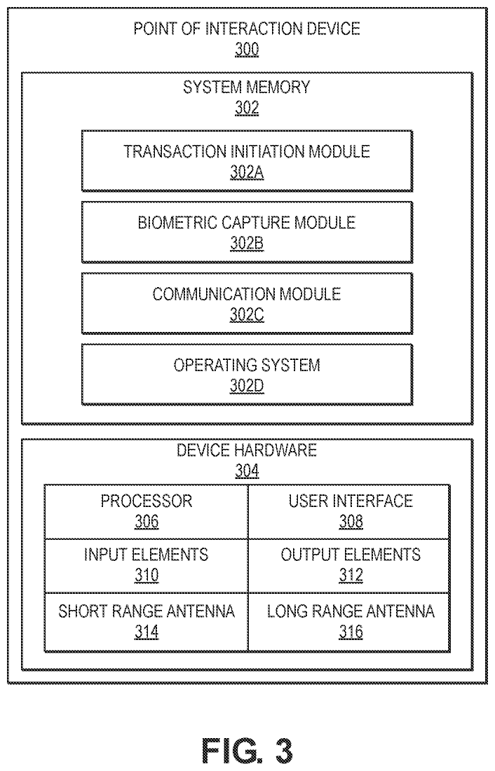

FIG. 3 illustrates a point of interaction device 300 according to an embodiment. The point of interaction device 300 may include device hardware 304 coupled to a system memory 302.

Device hardware 304 may include a processor 306, a short range antenna 314, a long range antenna 316, input elements 310, a user interface 308, and output elements 312 (which may be part of the user interface 308). Examples of input elements may include microphones, keypads, touchscreens, sensors, etc. Examples of output elements may include speakers, display screens, and tactile devices. The processor 306 can be implemented as one or more integrated circuits (e.g., one or more single core or multicore microprocessors and/or microcontrollers) and is used to control the operation of point of interaction device 300. The processor 306 can execute a variety of programs in response to program code or computer-readable code stored in the system memory 302 and can maintain multiple concurrently executing programs or processes.

The long range antenna 316 may include one or more RF transceivers and/or connectors that can be used by point of interaction device 300 to communicate with other devices and/or to connect with external networks. The user interface 308 can include any combination of input and output elements to allow a user to interact with and invoke the functionalities of point of interaction device 300.

The short range antenna 809 may be configured to communicate with external entities through a short range communication medium (e.g., using Bluetooth, Wi-Fi, infrared, NFC, etc.). The long range antenna 819 may be configured to communicate with a remote base station and a remote cellular or data network, over the air.

The system memory 302 can be implemented using any combination of any number of non-volatile memories (e.g., flash memory) and volatile memories (e.g., DRAM, SRAM), or any other non-transitory storage medium, or a combination thereof media. The system memory 302 may store computer code, executable by the processor 306, for performing any of the functions described herein.

The system memory 302 may also comprise a computer readable medium comprising a transaction initiation module 302A, a biometric capture module 302B, a communication module 302C, and an operating system 302D,

The transaction initiation module 302A may comprise code, executable by the processor 306 to initiate and conduct a transaction with an access device operated by a resource provider.

The biometric capture module 302B may comprise code, executable by the processor 306 to capture a biometric and create biometric data such as a biometric sample or a biometric template.

A communication module 302C may comprise code, executable by the processor 306 to communicate with external entities such as the identity service provider computer 30, the token requestor computer 40, and the access device 82.

The system memory 302 may also store an operating system 302D.

In some embodiments, the system memory 302 may comprise a computer readable medium comprising code executable by the processor 306 to perform operations or a method comprising receiving authentication data from a user; initiating verifying the authentication data with an identity service provider computer; receiving verification of the authentication data and linking data associated with the authentication data; and providing the verification of the authentication data, and the linking data to a token requestor computer, wherein the token requestor computer determines a token based on the linking data after analyzing the verification of the authentication data, requests and receives a cryptogram associated with the token from a token service computer, and transmits an authorization request message comprising the token and the cryptogram to a processor computer.

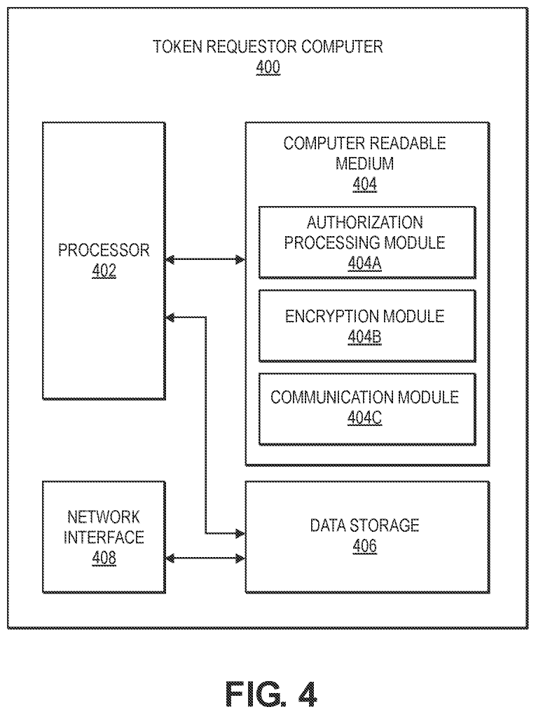

FIG. 4 shows a block diagram of an exemplary token requestor computer 400 according to an embodiment.

The token requestor computer 400 may comprise a processor 402, which may be coupled to a computer readable medium 404, a data storage 406, and a network interface 408.

The network interface 408 can comprise hardware and software to allow the token requestor computer 400 to communicate with external computers.

The data storage 406 may comprise one or more memory devices and may, and may store transaction data, linking data, tokens, and other information.

The computer readable medium 404 may comprise several software modules including an authorization processing module 404A, an encryption module 404B, and a communication module 404C.

The authorization processing module 404A may comprise code that can cause the processor 402 to generate and transmit authorization request messages for transactions and receive authorization response messages.

The encryption module 404B may include code, executable by the processor 402 to encrypt data and decrypt data. The encryption module 404B may also store any cryptographic keys needed to encrypt or decrypt data.

The communication module 404C may include code, executable by the processor 402, to allow for communication with external entities such as the point of interaction device and the processor computer 50.

The computer readable medium 404 may also comprise code executable by the processor 402 to perform a method comprising: receiving, from a point of interaction device, verification of authentication data and the linking data; determining a token based on the linking data after analyzing the verification of the authentication data; transmitting, to a token service computer, a cryptogram request message; receiving, from the token service computer, a cryptogram associated with the token; transmitting an authorization request message comprising the token and the cryptogram to a processor computer; and receiving an authorization response message from the processor computer.

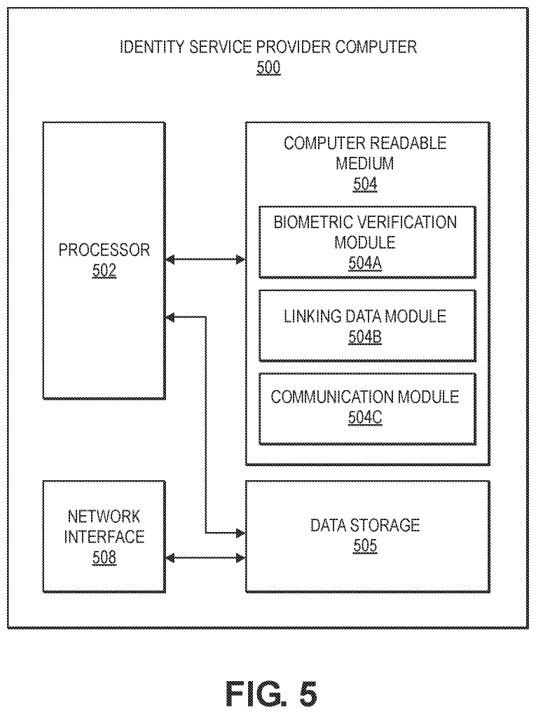

FIG. 5 shows a block diagram of an exemplary identity service provider computer 500 according to an embodiment.

The identity service provider computer 500 may comprise a processor 502, which may be coupled to a computer readable medium 504, a data storage 506, and a network interface 508.

The network interface 508 can comprise hardware and software to allow the identity service provider computer 500 to communicate with external computers.

The data storage 506 may comprise one or more memory devices and may, and may store biometric data, linking data, and other data associated with users or their accounts or enrollment.

The computer readable medium 404 may comprise several software modules including an authorization processing module 404A, an encryption module 404B, and a communication module 404C.

The biometric verification module 504A may comprise code that can cause the processor 502 to verify received biometric data (e.g., biometric samples or templates) against stored biometric data to determine if there is a match. In some cases, the match may be determined based upon a threshold of similarity (e.g., greater than 90 percent of features in two biometric data instances are similar).

The linking data module 504B may include code, executable by the processor 402 to create or obtain linking data. The linking data can be retrieved from a pool of linking data values in the data storage 505, or it can be generated in response to each user registration.

The communication module 504C may include code, executable by the processor 502, to allow for communication with external entities.

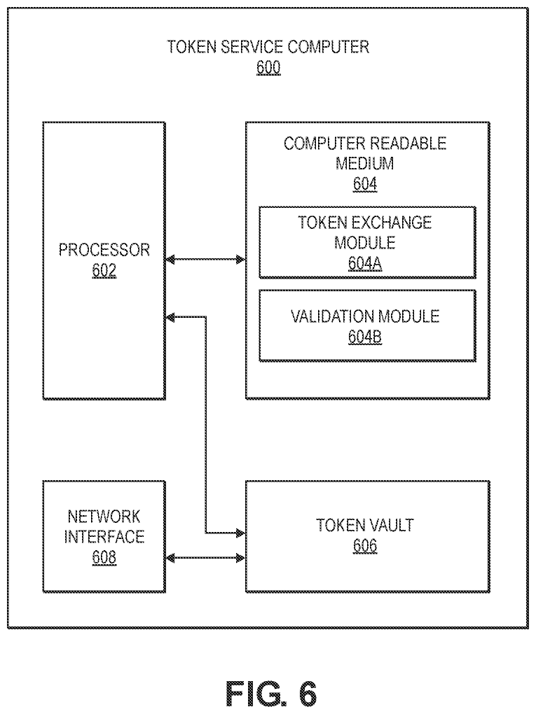

FIG. 6 shows a token service computer 600. The token service computer 600 includes a processor 602 and a computer readable medium 604, a token vault 606, and a network interface 608 coupled to the processor 602.

The computer readable medium 604 may comprise a token exchange module 604A and a validation module 604B.

The token vault 606 may store tokens and their associated credentials in a database. The token vault 606 may store data in a database such as an Oracle™ database.

The tokenization exchange module 604A may comprise code that causes the processor 602 to provide access tokens. For example, the token exchange module 604A may contain logic that causes the processor 602 to generate a payment token and/or associate the payment token with a set of payment credentials. A token record may then be stored in a token record database indicating that the payment token is associated with a certain user or a certain set of payment credentials.

The validation module 604B may comprise code that causes the processor 602 to validate token requests before a payment token is provided. For example, validation module 604B may contain logic that causes the processor 602 to confirm that a token request message is authentic by decrypting (or re-creating) a cryptogram included in the message, by confirming that the payment credentials are authentic and associated with the requesting device, by assessing risk associated with the requesting device.

Embodiments of the invention have a number of technical advantages as they improve data security, while also making interactions easier for users to conduct. For example, the users only need to provide a biometric at a point of interaction device to conduct a secure interaction. The user does not need to use additional devices. Also, in embodiments of the invention, the user's biometric data is stored within a secure identity service provider computer, and a token is used to initiate interactions instead of real credentials, thereby protecting the real credentials from man-in-the-middle attacks and hacking. Still further, a cryptogram is provided on a per interaction basis, and needs to be validated before the interaction is approved. Thus, there are multiple layers of security, and the user's sensitive information is stored at different, secure places within the overall system. As a result, a hacker that hacks into one computer would not have the data from the other computer storing sensitive data, thereby preventing the hacker from fraudulently conducting interactions. Still further, any resource providers that operate access devices are never in possession of either a user's biometric data, credential, or token. Some resource providers (e.g., merchants) may not have the same level of data security as many back end processors. Although the resource providers do not have access to the user's sensitive information, the user can nonetheless conduct an interaction in a secure and convenient manner.

Any of the computing devices described herein may be an example of a computer system that may be used to implement any of the entities or components described above. The subsystems of such a computer system may be interconnected via a system bus. Additional subsystems include a printer, keyboard, storage device, and monitor, which is coupled to display adapter. Peripherals and input/output (I/O) devices, which couple to I/O controller, can be connected to the computer system by any number of means known in the art, such as a serial port. For example, I/O port or external interface can be used to connect the computer apparatus to a wide area network such as the Internet, a mouse input device, or a scanner. The interconnection via system bus may allow the central processor to communicate with each subsystem and to control the execution of instructions from system memory or the storage device, as well as the exchange of information between subsystems. The system memory and/or the storage device may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a token requestor computer from a point of interaction device, verification of authentication data, and linking data;
determining, by the token requestor computer, a token based on the linking data after analyzing the verification of the authentication data;
transmitting, by the token requestor computer to a token service computer, a cryptogram request message;
receiving, by the token requestor computer from the token service computer, a cryptogram associated with the token;
transmitting, by the token requestor computer, an authorization request message comprising the token and the cryptogram to a processor computer; and
receiving, by the token requestor computer, an authorization response message from the processor computer.

2. The method of claim 1, wherein the authentication data is based on a biometric of a user that operates the point of interaction device.

3. The method of claim 1, further comprising:
receiving, by the token requestor computer from the point of interaction device, interaction data along with the authentication data and the linking data to the token requestor computer.

4. The method of claim 3, wherein the interaction data was obtained to the point of interaction device from an access device operated by a resource provider that conducts an interaction with a user interacting with the point of interaction device.

5. The method of claim 4, further comprising:
providing, by the token requestor computer, a notification regarding the authorization response message after receiving the authorization response message from the processing computer.

6. The method of claim 5, wherein the processor computer modifies the authorization request message to include a credential in place of the token to form a modified authorization request message and forwards the modified authorization request message to an authorizing entity computer, which generates the authorization response message.

7. The method of claim 1, wherein the point of interaction device provided authentication data to an identity service provider computer and received the verification of the authentication data before the token requestor computer receives the verification of the authentication data from the point of interaction device.

8. The method of claim 1, wherein the point of interaction device is a mobile phone.

9. The method of claim 1, wherein the cryptogram request message comprises the token.

10. The method of claim 1, wherein the authentication data comprises a biometric of a user operating the point of interaction device.

11. The method of claim 1, wherein the point of interaction device provided authentication data to an identity service provider computer and received the verification of the authentication data before the token requestor computer receives the verification of the authentication data from the point of interaction device, and wherein the method further comprises, before the token requestor computer receives the verification of the authentication data, and the linking data:
receiving, by the token requestor computer from the identity service provider computer, the linking data and a credential;
transmitting, by the token requestor computer to the token service computer, the credential; and
receiving, by the token requestor computer from the token service computer, the token.

12. The method of claim 11, further comprising:
storing the token.

13. The method of claim 1, wherein the token requestor computer is a cloud based computer system.

14. The method of claim 1, wherein linking data comprises an alphanumeric string of data that links a credential associated with the token and the authentication data, the authentication data comprising a biometric.

15. A token requestor computer comprising:
a processor; and
a non-transitory computer readable medium, the non-transitory computer readable medium comprising code executable by the processor to perform a method comprising:
receiving, from a point of interaction device, verification of authentication data, and linking data;
determining a token based on the linking data after analyzing the verification of the authentication data;
transmitting, to a token service computer, a cryptogram request message;
receiving, from the token service computer, a cryptogram associated with the token;
transmitting an authorization request message comprising the token and the cryptogram to a processor computer; and
receiving an authorization response message from the processor computer.

16. A method, comprising:
receiving, by a point of interaction device, authentication data from a user;
initiating, by the point of interaction device, verifying the authentication data with an identity service provider computer;
receiving, by the point of interaction device, verification of the authentication data and linking data associated with the authentication data; and
providing, by the point of interaction device, the verification of the authentication data, and the linking data to a token requestor computer, wherein the token requestor computer determines a token based on the linking data after analyzing the verification of the authentication data, requests and receives a cryptogram associated with the token from a token service computer, and transmits an authorization request message comprising the token and the cryptogram to a processor computer.

17. The method of claim 16, wherein the authentication data comprises a biometric.

18. The method of claim 16, further comprising:
receiving, by the point of interaction device, interaction data from an access device, and providing the interaction data along with the authentication data and the linking data to the token requestor computer.

19. The method of claim 18, further comprising:
initiating communication with the access device prior to receiving the interaction data from the access device.

20. The method of claim 19, wherein the access device provides access to a resource.
